(19) United States
(12) Patent Application Publication
(10) Pub. No.: US 2021/0119343 A1
(43) Pub. Date: Apr. 22, 2021

(54) CAPACITIVE STEALTH COMPOSITE STRUCTURE

(71) Applicant: National Tsing Hua University, Hsinchu City (TW)

(72) Inventors: Hao-Wei Fu, Hsinchu City (TW); Hsin-Jung Tsai, Hsinchu City (TW); Wen-Kuang Hsu, Hsinchu City (TW)

(73) Assignee: National Tsing Hua University, Hsinchu City (TW)

(21) Appl. No.: 16/842,772

(22) Filed: Apr. 8, 2020

(30) Foreign Application Priority Data
Oct. 17, 2019 (TW) 108137535

(51) Int. Cl. H01Q 17/00; B32B 5/02; B32B 5/26

(52) U.S. Cl. CPC H01Q 17/005; B32B 5/02; B32B 5/26; B32B 2307/212; B32B 2255/02; B32B 2255/26; B32B 2262/101; B32B 2250/20

(57) ABSTRACT

A capacitive stealth composite structure includes a plurality of structural layers stacked in a thickness direction, and the number of layers of the structural layers is three or more, wherein each of the structural layers consists of a plurality of electromagnetic wave absorbing patterns and a plurality of insulation patterns alternately arranged in a horizontal direction. The electromagnetic wave absorbing patterns in each of the structural layers are aligned with the insulation patterns of an adjacent structural layer, and the insulation patterns in each of the structural layers are aligned with the electromagnetic wave absorbing patterns of an adjacent structural layer.

### CROSS-REFERENCE TO RELATED APPLICATION

This application claims the priority benefit of Taiwan application serial no. 108137535, filed on Oct. 17, 2019. The entirety of the above-mentioned patent application is hereby incorporated by reference herein and made a part of this specification.

### BACKGROUND OF THE INVENTION

### Field of the Invention

The invention relates to stealth technology, and more particularly to a capacitive stealth composite structure.

### Description of Related Art

The so-called stealth technology mainly uses two methods to reduce the radar cross section (RCS) reflected from the target to the radar. The first common method is to reflect an electromagnetic wave emitted by a radar to a direction in which signals may not be intercepted by a radar receiving station by changing the geometric shape. In the other method, a material having the property of absorbing electromagnetic waves is added to the outer casing of a fighter or a warship to achieve stealth by changing geometric shape.

However, the former requires changing the shape of the aircraft, which changes the aerodynamics and affects the speed of the aircraft; the latter produces conical edge scattering at the edge of the material and the intersection between the materials and reduces the absorption effect.

Due to the inherent impedance of the material itself having the property of absorbing electromagnetic waves not matching the inherent impedance of the air, the electromagnetic waves emitted by the radar are often reflected before entering the material for absorption, thus affecting stealth.

### SUMMARY OF THE INVENTION

The invention provides a capacitive stealth composite structure having the properties of light weight, small thickness, and improved electromagnetic wave absorption pattern.

A capacitive stealth composite structure of the invention includes a plurality of structural layers stacked in a thickness direction, and the number of layers of the structural layers is 3 or more, wherein each of the structural layers consists of a plurality of electromagnetic wave absorbing patterns and a plurality of insulation patterns alternately arranged in a horizontal direction. The electromagnetic wave absorbing patterns in each of the structural layers are aligned with the insulation patterns of an adjacent structural layer, and the insulation patterns in each of the structural layers are aligned with the electromagnetic wave absorbing patterns of an adjacent structural layer.

In an embodiment of the invention, a material of the electromagnetic wave absorbing patterns is selected from at least one of carbon nanotubes, carbon black, ferrite, iron nitride, carbonyl iron, polycrystalline iron, magnetic powder with iron cobalt nickel, carbon fiber, silicon carbide, and activated carbon.

In an embodiment of the invention, the material of the electromagnetic wave absorbing patterns may further include a resin.

In an embodiment of the invention, a material of the insulation patterns includes a thermosetting resin such as an epoxy resin, a phenol resin, a melamine resin, a urea resin, a polyester resin, a urethane resin, or an acrylic resin; or a thermoplastic resin such as polyethylene, polypropylene, an ethylene-vinyl acetate copolymer, polyvinyl chloride, polyvinylidene chloride, polystyrene, acrylic, polyvinyl alcohol, or polyethylene terephthalate.

In an embodiment of the invention, a spacing between the electromagnetic wave absorbing patterns in the horizontal direction is between 3 cm and 10 cm.

In an embodiment of the invention, a thickness of each of the structural layers may be 3 mm or less.

In an embodiment of the invention, the capacitive stealth composite structure may further include a reinforcing material disposed in the electromagnetic wave absorbing patterns and the insulation patterns in each of the structural layers.

In an embodiment of the invention, the reinforcing material is made of, for example, glass fiber, carbon fiber, aromatic polyamide fiber, or the like, or adopts a natural material such as paper, wood, asbestos, or basalt fiber as fiber.

In an embodiment of the invention, a shielding band of the capacitive stealth composite structure is, for example, 8 GHz to 12 GHz.

In an embodiment of the invention, a shielding band of the capacitive stealth composite structure is variable with a spacing of the electromagnetic wave absorbing patterns.

Based on the above, in the invention, via electromagnetic wave absorbing patterns and insulation patterns alternately arranged in the thickness direction and the horizontal direction, the effect of improved the electromagnetic wave absorptivity is achieved.

In order to make the aforementioned features and advantages of the disclosure more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram of a capacitive stealth composite structure according to an embodiment of the invention.

FIG. 2 is a schematic diagram of a capacitive stealth composite structure according to another embodiment of the invention.

FIG. 3 is a flowchart of the manufacture of a capacitive stealth composite structure according to another embodiment of the invention.

FIG. 4 is a schematic view of an apparatus for performing electromagnetic wave absorption analysis.

FIG. 5 is a graph of the relationship between frequency and reflection loss of Experimental example 1 and Comparative examples 1 and 2.

FIG. 6 is a graph of the relationship between frequency and reflection loss of Experimental examples 1 to 3.

### DESCRIPTION OF THE EMBODIMENTS

Some embodiments are provided hereinafter and described in detail with reference to figures. However, the embodiments provided are not intended to limit the scope of the invention. Moreover, the figures are only descriptive and are not drawn to scale. For ease of explanation, the same devices below are provided with the same reference numerals.

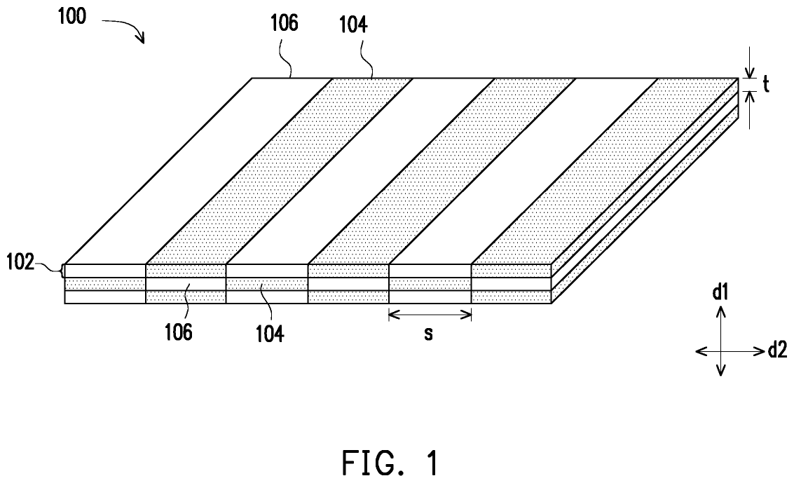

FIG. 1 is a schematic diagram of a capacitive stealth composite structure according to an embodiment of the invention.

Referring to FIG. 1, a capacitive stealth composite structure 100 of the present embodiment includes a plurality of structural layers 102 stacked along a thickness direction d1, the number of layers of the structural layers 102 is three or more, and a thickness t of each of the structural layer 102 is, for example, 3 mm or less. Preferably, the thickness t of a single structural layer 120 is less to achieve a better electromagnetic wave absorption effect. Further, each of the structural layers 102 consists of a plurality of electromagnetic wave absorbing patterns 104 and a plurality of insulation patterns 106 alternately arranged in a horizontal direction d2. The electromagnetic wave absorbing patterns 104 in each of the structural layers 102 are aligned with the insulation patterns 106 of the adjacent structural layer 102, and the insulation patterns 106 in each of the structural layers 102 are aligned with the electromagnetic wave absorbing patterns 104 of the adjacent structural layer 102. In an embodiment, the material of the electromagnetic wave absorbing patterns 104 includes a material that may produce dielectric loss and a material that may produce magnetic loss, such as carbon nanotubes (CNTs), carbon black (CB), carbonyl iron (CI), ferrite, iron nitride, polycrystalline iron, magnetic powder with iron cobalt nickel, carbon fiber, silicon carbide, activated carbon, etc. The material of the insulation patterns 106 may be a thermosetting resin or a thermoplastic resin. The thermosetting resin may be an epoxy resin, a phenol resin, a melamine resin, a urea resin, a polyester resin, a urethane resin, an acrylic resin, or the like. The thermoplastic resin may be a thermoplastic resin such as polyethylene, polypropylene, ethylene-vinyl acetate copolymer, polyvinyl chloride, polydivinylidene chloride, polystyrene, acrylic, polyvinyl alcohol, or polyethylene terephthalate. Since the inherent impedance of the insulation patterns 106 is closer to the inherent impedance of the air than the inherent impedance of the electromagnetic wave absorbing patterns 104, when an electromagnetic wave is in contact with the capacitive stealth composite structure 100, a large portion enters therein and is absorbed by the electromagnetic wave absorbing patterns 104 to enhance the electromagnetic wave absorption effect. In an embodiment, a spacing s between the electromagnetic wave absorbing patterns 104 in the horizontal direction is, for example, between 3 cm and 10 cm, but the invention is not limited thereto; preferably, the spacing s is less to achieve a better electromagnetic wave absorption effect. In addition, it has been experimentally proved that the shielding band of the capacitive stealth composite structure 100 may be in the X band (8 GHz to 12 GHz), and the shielding band of the capacitive stealth composite structure may be adjusted with the spacing of the electromagnetic wave absorbing patterns, and therefore the spacing s may be 3 cm or less or 10 cm or more.

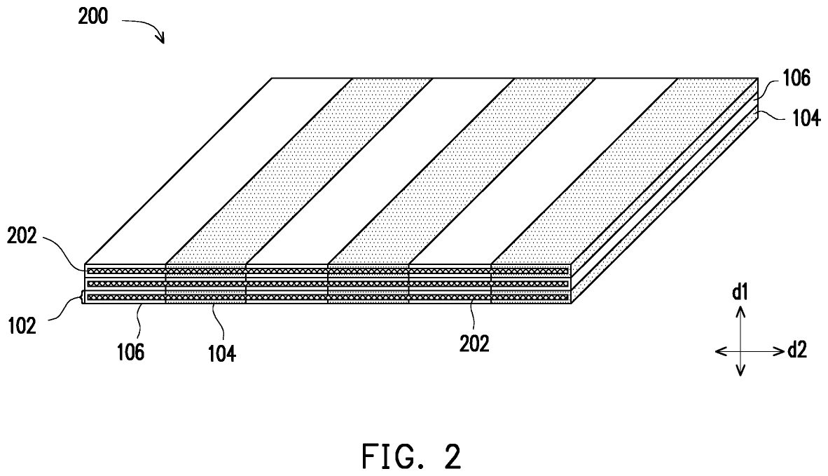

FIG. 2 is a schematic diagram of a capacitive stealth composite structure according to another embodiment of the invention, wherein the reference numerals and part of the content of FIG. 1 are adopted and the same reference numerals are used to denote the same or similar elements, and the description of the same technical content is omitted. For the description of the omitted part, reference may be made to the content of the previous embodiment and is not repeated below.

In FIG. 2, a capacitive stealth composite structure 200 may further include a reinforcing material 202 disposed in the electromagnetic wave absorbing patterns 104 and the insulation patterns 106 in each of the structural layers 102, wherein the reinforcing material 202 is, for example, glass fiber, carbon fiber, or aromatic polyamide fiber, or the like, or paper fiber, wood fiber, asbestos fiber, or basalt fiber made of a natural material such as paper, wood, asbestos, or basalt. For example, if the reinforcing material 202 is a glass fiber cloth, then the material of the electromagnetic wave absorbing patterns 104 may include a resin as a binder in addition to the material that may produce dielectric loss and the material that may produce magnetic loss, and the resin may be the same as or different from the resin used for the insulation patterns 106.

A manufacturing method of a capacitive stealth composite structure is provided below, but the invention is not limited thereto.

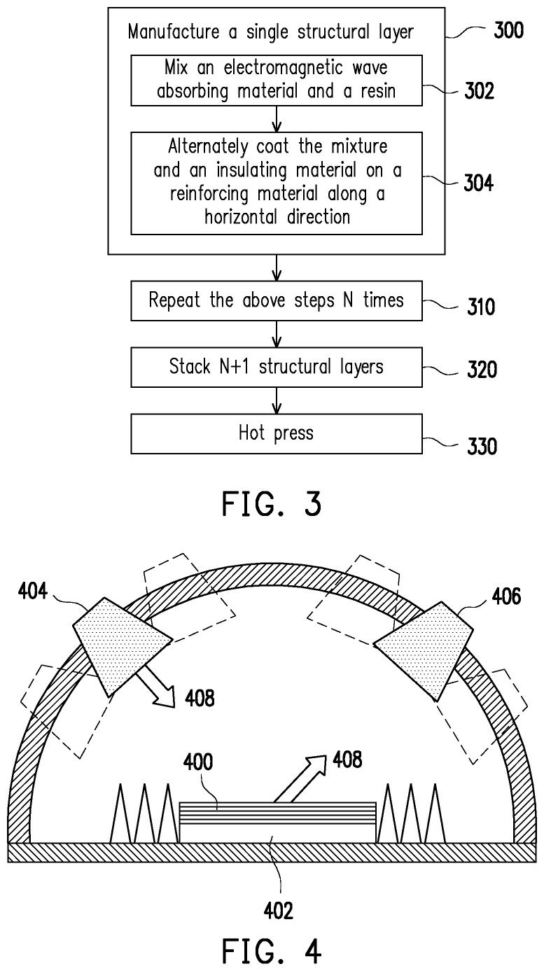

FIG. 3 is a flowchart of the manufacture of a capacitive stealth composite structure according to yet another embodiment of the invention.

Referring to FIG. 3, in step 300, a single structural layer is manufactured, and the present embodiment is exemplified by a structural layer containing a reinforcing material. For example, step 302 may be first performed to mix an electromagnetic wave absorbing material and a resin to obtain a uniformly mixed mixture; then, step 304 is performed to alternately coat the mixture and the insulating material on the reinforcing material in the horizontal direction to obtain a plurality of electromagnetic wave absorbing patterns and a plurality of insulation patterns alternately arranged in the horizontal direction. The selection of the reinforcing material, the electromagnetic wave absorbing material (that is, the material of the electromagnetic wave absorbing patterns), the insulating material (that is, the material of the insulation patterns), and the resin is as provided in the contents of the above embodiments and is not repeated.

Next, in step 310, the above steps are repeated N times to obtain N+1 structural layers, wherein N is a positive integer.

Then, in step 320, the N+1 structural layers are stacked, and the electromagnetic wave absorbing patterns in each structural layer need to be aligned with the insulation patterns of an adjacent structural layer, and the insulation patterns in each structural layer also need to be aligned with the electromagnetic wave absorbing patterns of an adjacent structural layer.

Thereafter, in step 330, hot pressing is performed. The temperature range and time of the hot pressing may be adjusted according to the type of material contained in the structural layers, the thickness of the structural layers, or the area size of the structural layers.

In addition, if the structural layers do not contain a reinforcing material, other manufacture means may be adopted, such as coating the surface of a metal substrate (such as an aircraft casing) layer by layer to manufacture the capacitive stealth composite structure 100 as shown in FIG. 1.

To verify the effects of the invention, experiments are provided below, but the invention is not limited to the experiments below.

<Electromagnetic Wave Absorption Analysis>

The analysis was performed using the Arch Method of the United States Naval Research Laboratory (NRL), as shown in FIG. 4.

In FIG. 4, an object to be tested 400 is placed on an aluminum plate 402, and electromagnetic waves 408 of different frequencies are emitted on the surface of the object to be tested 400 using a movable transmitting end 404 and a receiving end 406 (the dotted line represents 404 and 406 moving to different positions), and the electromagnetic waves 408 reflected back from the object to be tested 400 are received. According to the electromagnetic wave energy comparison between the transmitting end 404 and the receiving end 406, reflection loss may be obtained.

### EXPERIMENTAL EXAMPLE 1

A capacitive stealth composite structure was manufactured according to the steps of FIG. 3, wherein the reinforcing material was glass fiber cloth, the insulating material was epoxy resin, and the electromagnetic wave absorbing material contained 2 phr of carbon nanotubes, 200 phr of carbonyl iron, and an epoxy resin, wherein phr is the number of parts added per 100 parts by mass of the resin.

First, the electromagnetic wave absorbing material was stirred by a triaxial roller for 1 hour and vacuum pumped, and the mixed electromagnetic wave absorbing material and the insulating material were alternately coated on the glass fiber cloth in a horizontal direction by pouring, wherein the width of the electromagnetic wave absorbing patterns was about 3 cm to 10 cm and the spacing of the electromagnetic wave absorbing patterns was about 3 cm to 10 cm, and the width of the electromagnetic wave absorbing patterns was substantially equal to the spacing between the electromagnetic wave absorbing patterns.

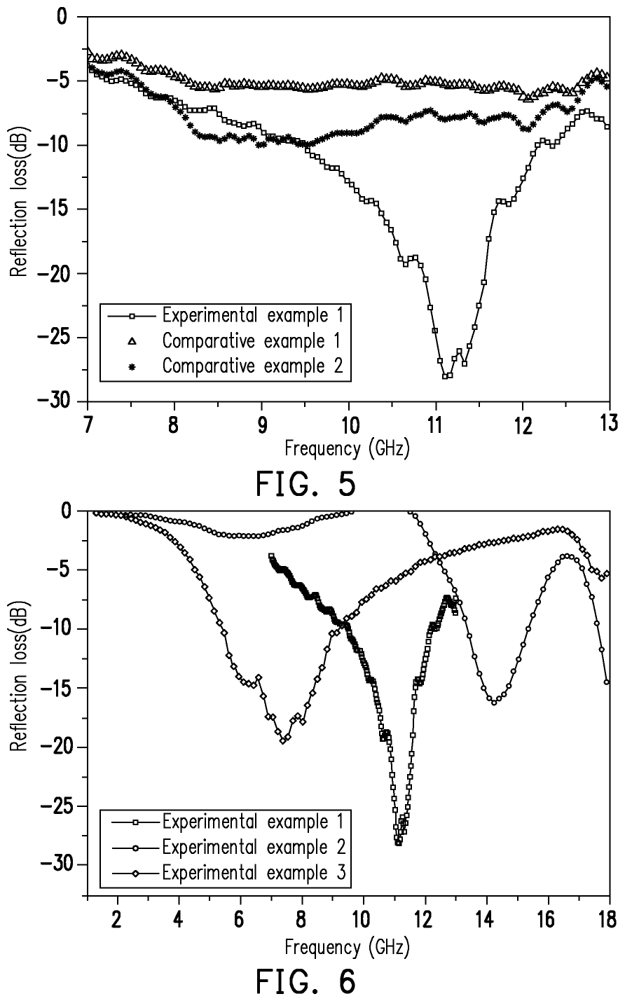

The above steps were repeated to prepare three structural layers, and the three structural layers were alternately stacked and hot-pressed at 120° C. for 3 hours to obtain the capacitive stealth composite structure of Experimental example 1. Then, electromagnetic wave absorption analysis was performed, and the results are shown in FIG. 5 and FIG. 6, respectively.

### COMPARATIVE EXAMPLE 1

Similar to the preparation method of Experimental example 1, but the entire surface of the electromagnetic wave absorbing material was directly coated on the glass fiber cloth without an insulation pattern. Then, electromagnetic wave absorption analysis was performed, and the results are shown in FIG. 5.

### COMPARATIVE EXAMPLE 2

Similar to the preparation method of Comparative example 1, but structural layers were added to form a composite structure obtained by stacking and hot pressing four structural layers. Then, electromagnetic wave absorption analysis was performed, and the results are shown in FIG. 5.

It may be seen from FIG. 5 that the capacitive stealth composite structure of Experimental example 1 had significant reflection loss in the band of 9.49 GHz to 12.38 GHz, which was sufficient to prove that the electromagnetic wave absorption effect of the capacitive stealth composite structure of the invention in the X band was superior to that of Comparative examples 1 and 2.

### EXPERIMENTAL EXAMPLE 2

Similar to the preparation method of Experimental example 1, but the spacing between the electromagnetic wave absorbing patterns was changed to 10 cm. Then, electromagnetic wave absorption analysis was performed, and the results are shown in FIG. 6.

### EXPERIMENTAL EXAMPLE 3

Similar to the preparation method of Experimental example 1, but the spacing between the electromagnetic wave absorbing patterns was changed to 3 cm. Then, electromagnetic wave absorption analysis was performed, and the results are shown in FIG. 6.

As may be seen from FIG. 5, as the spacing of the electromagnetic wave absorbing patterns was changed, the band in which the capacitive stealth composite structure had the electromagnetic wave absorption pattern was also changed, so that the electromagnetic wave absorbing pattern spacing in the capacitive stealth composite structure may be adjusted according to the application surface.

For example, if based on a reflection loss of −10 dB, the shielding band of Experimental example 1 was 8.49 GHz to 12.38 GHz, which is applicable to the electromagnetic wave shielding of radars, satellite communication, and speed guns. The shielding band of Experimental example 2 was 13.4 GHz to 15.3 GHz, which is applicable to the electromagnetic wave shielding of satellite communication and speed cameras. The shielding band of Experimental example 3 was 5.2 GHz to 9.25 GHz, which is applicable to the electromagnetic wave shielding of, for example, electronic toll collection (ETC), Wi-Fi, satellite communication, and the like.

Based on the above, the capacitive stealth composite structure of the invention is configured by interleaving electromagnetic absorbing patterns and insulation patterns of similar capacitance in both the thickness direction and the horizontal direction to reduce impedance mismatch, enhance destructive interference, control the position of maximum reflection loss, and increase the capacity of dissipation of electromagnetic waves in the electromagnetic wave absorbing material, so that the capacitive stealth composite structure may be applied to electromagnetic wave shielding at various frequencies, such as the X band range commonly used in the military. Moreover, by the addition of the reinforcing material, a composite structure having mechanical strength may be directly formed without the issue of peeling off.

Although the invention has been described with reference to the above embodiments, it will be apparent to one of ordinary skill in the art that modifications to the described embodiments may be made without departing from the spirit of the invention. Accordingly, the scope of the invention is defined by the attached claims not by the above detailed descriptions.

What is claimed is:

1. A capacitive stealth composite structure, comprising:
a plurality of structural layers stacked in a thickness direction, and a number of layers of the plurality of structural layers is three or more, wherein
each of the structural layers consists of a plurality of electromagnetic wave absorbing patterns and a plurality of insulation patterns alternately arranged in a horizontal direction, and
the electromagnetic wave absorbing patterns in each of the structural layers are aligned with the insulation patterns of an adjacent structural layer, and the insulation patterns in each of the structural layers are aligned with the electromagnetic wave absorbing patterns of an adjacent structural layer.

2. The capacitive stealth composite structure of claim 1, wherein a material of the electromagnetic wave absorbing patterns is selected from at least one of carbon nanotubes, carbon black, ferrite, iron nitride, carbonyl iron, polycrystalline iron, magnetic powder with iron cobalt nickel, carbon fiber, silicon carbide, and activated carbon.

3. The capacitive stealth composite structure of claim 2, wherein the material of the electromagnetic wave absorbing patterns further comprises a resin.

4. The capacitive stealth composite structure of claim 1, wherein a material of the insulation patterns comprises an epoxy resin, a phenol resin, a melamine resin, a urea resin, a polyester resin, a urethane resin, an acrylic resin, polyethylene, polypropylene, an ethylene-vinyl acetate copolymer, polyvinyl chloride, polyvinylidene chloride, polystyrene, acrylic, polyvinyl alcohol, or polyethylene terephthalate.

5. The capacitive stealth composite structure of claim 1, wherein a spacing of the plurality of electromagnetic wave absorbing patterns in the horizontal direction is between 3 cm and 10 cm.

6. The capacitive stealth composite structure of claim 1, wherein a thickness of each of the structural layers is 3 mm or less.

7. The capacitive stealth composite structure of claim 1, further comprising a reinforcing material disposed in the plurality of electromagnetic wave absorbing patterns and the plurality of insulation patterns in each of the structural layers.

8. The capacitive stealth composite structure of claim 7, wherein the reinforcing material comprises glass fiber, carbon fiber, aromatic polyamide fiber, paper fiber, wood fiber, asbestos fiber, or basalt fiber.

9. The capacitive stealth composite structure of claim 1, wherein a shielding band of the capacitive stealth composite structure is 8 GHz to 12 GHz.

10. The capacitive stealth composite structure of claim 1, wherein a shielding band of the capacitive stealth composite structure is variable with a spacing of the plurality of electromagnetic wave absorbing patterns.
